(19) United States
(12) Patent Application Publication
(10) Pub. No.: US 2005/0078325 A1
(43) Pub. Date: Apr. 14, 2005

(54) Image regulation apparatus and image regulation method

(75) Inventors: Hiroaki Momose, Nagano-ken (JP); Tatsuya Kitazawa, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/616,225

(22) Filed: Jul. 10, 2003

(30) Foreign Application Priority Data
Jul. 11, 2002 (JP) 2002-202398

(51) Int. Cl. H04N 1/56

(52) U.S. Cl. 358/1.9

(57) ABSTRACT

The procedure of the invention sets a transparent area on an image consisting of multiple pixels. Each pixel has, as parameters, three channels respectively having tone values in a predetermined range with regard to three primary colors, R, G, and B and an alpha channel having a tone value in a predetermined range that represents a degree of transparency. In response to specification of a degree of transparency and its range to set a transparent area, the procedure inputs a data value Ain of the alpha channel representing the specified degree of transparency and the specified range of the transparent area, and compares the input data value Ain with a current setting of data value A of the alpha channel with respect to each of the pixels in the specified range. The procedure updates the current setting of data value A to the input data value Ain with respect to only pixels having the data value Ain smaller than the current setting of data value A (that is, pixels of opaqueness), calculates a tone value of each corresponding pixel from the updated data value A, and displays a transparent area on the image, based on the calculated tone values.

### BACKGROUND OF THE INVENTION

1. Field of the Invention

The present invention relates to an image regulation apparatus that regulates an image, and a corresponding image regulation method.

2. Description of the Prior Art

A proposed image regulation apparatus sets a transparent area on an image displayed in an image area. This prior art image regulation apparatus may lay out multiple image areas in layers and set a transparent area on an image in the image area of an upper layer (for example, a frame image) to make an image in the image area of a lower layer (for example, a photographic image) seeable through the transparent area. This arrangement is supposed to attain diverse layouts.

In the case of newly setting a transparent area having a different degree of transparency over a preset transparent area in an overlapping manner, however, this prior art image regulation apparatus updates the degree of transparency in the whole preset transparent area to the degree of transparency of the newly set transparent area. This undesirably narrows the degree of freedom in setting of transparent areas.

### SUMMARY OF THE INVENTION

The object of the present invention is thus to provide an image regulation apparatus and a corresponding image regulation method that solve the problem of the prior art technique discussed above and ensure diverse settings of transparent areas on an image displayed in an image area.

In order to achieve at least a part of the aforementioned object, the image regulation apparatus and the corresponding image regulation method are structured as follows.

An image regulation apparatus of the present invention is an apparatus that regulates an image, the image regulation apparatus including: a transparency specification module that specifies a degree of transparency; a transparent range specification module that specifies an arbitrary range of an image as a transparent range; and a transparency setting module that, in response to specification of the transparent range, sets a new degree of transparency for an image in the transparent range, based on a current setting of transparency for the image in the transparent range and the degree of transparency specified by the transparency specification module.

The image regulation apparatus of the invention specifies a degree of transparency and an arbitrary range of an image as a transparent range, and in response to specification of a transparent range, sets a new degree of transparency for an image in the transparent range, based on a current setting of transparency for the image in the specified transparent range and the specified degree of transparency. This technique of the invention does not specify a uniform degree of transparency in a transparent area set on an image, but takes into account a preset degree of transparency for a new setting of transparency. This arrangement ensures settings of transparent areas having diverse degrees of transparency.

In the image regulation apparatus of the invention, as one aspect, the transparency setting module may selectively set a lower degree of transparency between the specified degree of transparency and the current setting of transparency, as the new degree of transparency for the image in the transparent range, or may selectively set a higher degree of transparency between the specified degree of transparency and the current setting of transparency, as the new degree of transparency for the image in the transparent range.

In the image regulation apparatus of the invention, as another aspect, the transparency setting module may include: a first transparency setting sub-module that selectively sets a lower degree of transparency between the specified degree of transparency and the current setting of transparency, as the new degree of transparency for the image in the transparent range; and a second transparency setting sub-module that selectively sets a higher degree of transparency between the specified degree of transparency and the current setting of transparency, as the new degree of transparency for the image in the transparent range, and the image regulation apparatus of the invention may further include a selection module that selectively activates either of the first transparency setting sub-module and the second transparency setting sub-module.

In the image regulation apparatus of the present invention, as another aspect, the degree of transparency may be set for each pixel.

In the image regulation apparatus of the present invention, as still another aspect, the transparency specification module may be capable of specifying multiple stages of transparency in a range of 0 to 100%.

In the image regulation apparatus of the invention, as still another aspect, the transparent range specification module may specify two points to define the transparent range.

The image regulation apparatus of the invention, as still another aspect, may be capable of regulate a layout of image areas in which images are displayed. Here, one of the image areas may be a frame image area, in which a frame image functioning as a frame of an arbitrary image is displayed.

The technique of the present invention is not restricted to the image regulation apparatus described above, but is also applicable to an image regulation method.

### BRIEF DESCRIPTION OF THE DRAWINGS

FIG. 1 schematically illustrates the construction of a printing system including an image regulation apparatus 20 in one embodiment of the invention;

FIG. 2 is a flowchart showing a main routine executed by the image regulation apparatus 20 of the embodiment;

FIG. 3 shows one example of a paper settings window 30;

FIG. 4 shows one example of a layout operation window 40 and a toolbox window 50;

FIG. 5 shows the layout operation window 40 and the toolbox window 50, on which insert photo frames 71 and 72 are set;

FIG. 6 shows one example of a transparent range setting window 80;

FIG. 7 is a flowchart showing a transparent area setting routine executed by the image regulation apparatus 20;

FIG. 8 shows a process of setting a transparent area; and

FIG. 9 shows a process of setting a transparent area.

### DESCRIPTION OF THE PREFERRED EMBODIMENTS

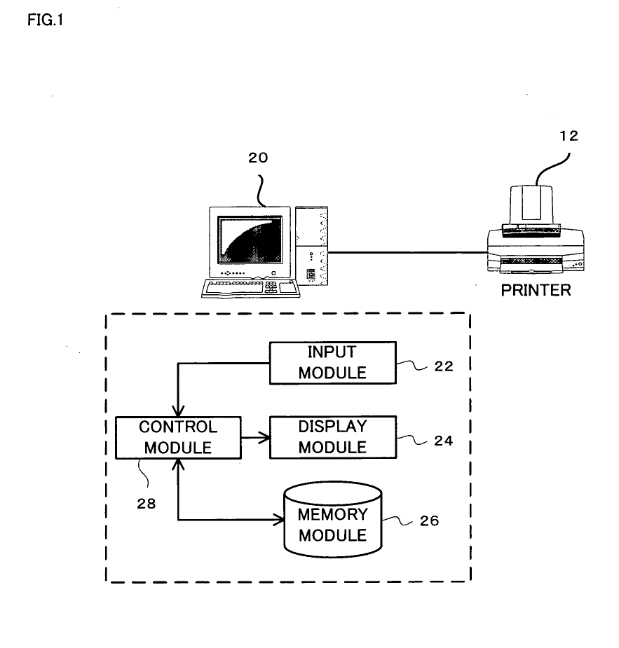

A preferred embodiment of the present invention is discussed below. FIG. 1 schematically illustrates the construction of a printing system including an image regulation apparatus 20 in one embodiment of the invention. The image regulation apparatus 20 of the embodiment is constructed as a general-purpose personal computer having a layout control program installed therein to lay out image areas for printing images. The image regulation apparatus 20 includes an input module 22 that inputs a user's commands via input devices like a keyboard and a mouse, a display module 24 that functions as a display, a memory module 26 that stores programs, images, and other data, and a control module 28 that executes preset arithmetic operations and controls the whole image regulation apparatus 20. A printer 12 is connected to the image regulation apparatus 20 of the embodiment. The printer 12 prints laid-out images on printing paper, in response to a printing instruction given by the personal computer, which functions as the image regulation apparatus 20.

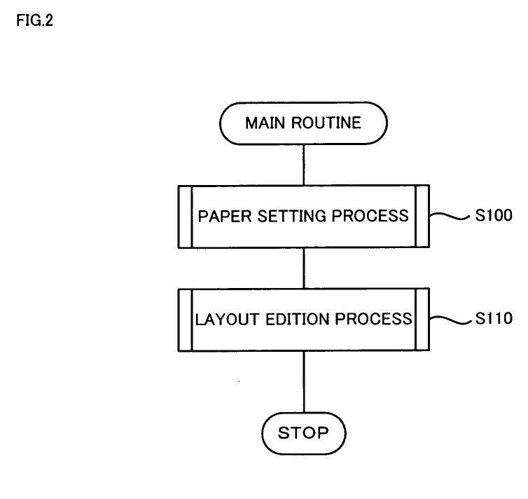

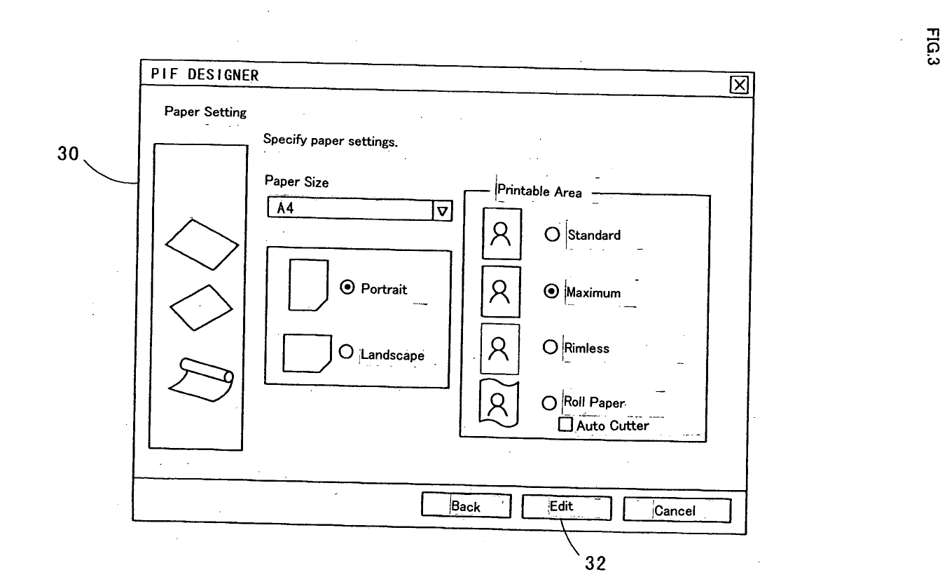

FIG. 2 is a flowchart showing a main routine executed by the image regulation apparatus 20 of the embodiment. This main routine follows the layout control program executed by the personal computer. The image regulation apparatus 20 of the embodiment first specifies settings of a paper size, a paper orientation, and a printable area on a paper settings window 30 shown in FIG. 3 (step S100). In the illustrated example of FIG. 3, the paper size is selectable from a pull-down menu, and the paper orientation is selectable between ‘Portrait’ and ‘Landscape’ by a click of a corresponding radio button. The printable area is selectable among several options, ‘Standard’ for setting standard margins on four sides, ‘Maximum’ for setting a maximum printable area, and ‘Rimless’ for rimless printing. In the ‘Rimless’ mode, negative values are set to the respective margins, in order to prevent the accidental occurrence of any small margins due to a positional shift of paper in the printing process. When an option ‘Roll Paper’ is selected as the setting of the paper size, setting of ‘Auto Cutter’ may be activated for automatic cutting after completion of printing.

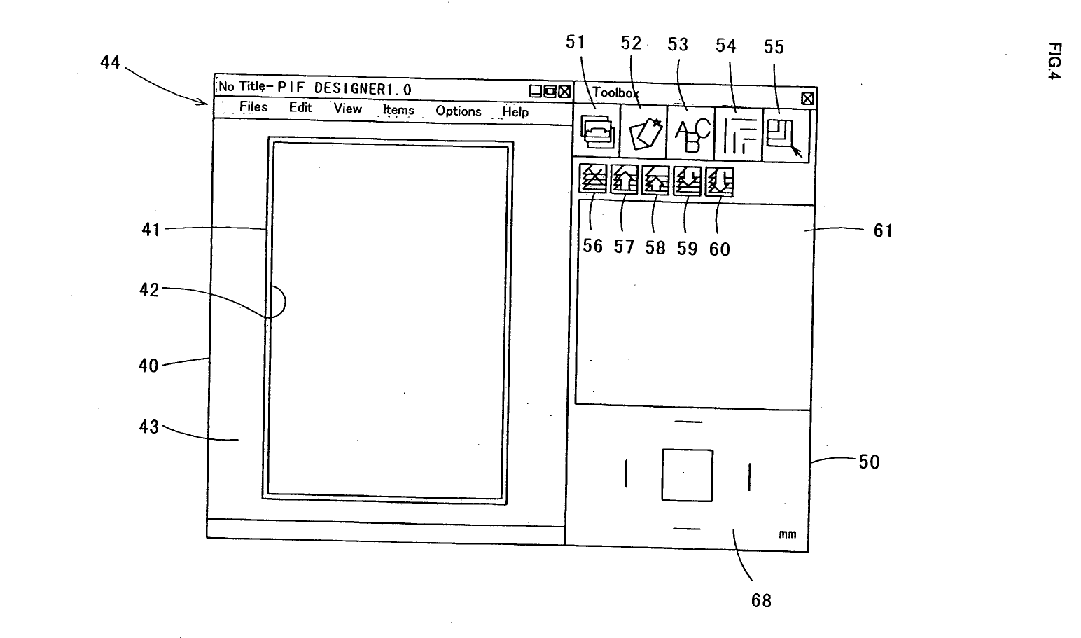

When the user specifies the respective settings and clicks an Edit button 32 on the paper settings window 30, a layout edition process is executed on a layout operation window 40 and a toolbox window 50 shown in FIG. 4 (step S110). The layout operation window 40 shown in FIG. 4 has a work area 43 in which a paper area 41 and a printable area 42 are displayed, and a toolbar 44 on which a desired operation, such as a file-related operation or an editing operation, is selected from a corresponding pull down menu. The toolbox window 50 has various buttons 51 through 60 to perform various operations in the printable area 42 of the layout operation window 40, an image area display operation box 61 to show priorities assigned to layers of image areas set in the printable area 42 and to specify a viewing status or a non-viewing status of each image area, and a positional information display box 68 to display positional information on a selected image area among the image areas set in the printable area 42 of the layout operation window 40 relative to the printable area 42. The buttons displayed in the toolbox window 50 include an insert photo frame button 51 for setting an image area to allow for insertion of a desired photographic or another image therein, a background/frame/ornamental frame button 52 for setting an image area to create a background, a frame, or an ornamental frame of a desired photographic or another image, a letter string button 53 for setting an area to input a letter string, a line button 54 for drawing straight lines, a select button 55 for selecting a desired image area, a delete button 56 for deleting a selected image area, an upper-most button 57 for shifting a selected image area to an upper-most layer, a front button 58 for shifting a selected image area to an upper layer by one, a back button 59 for shifting a selected image area to a lower layer by one, and a lower-most button 60 for shifting a selected image area to a lower-most layer.

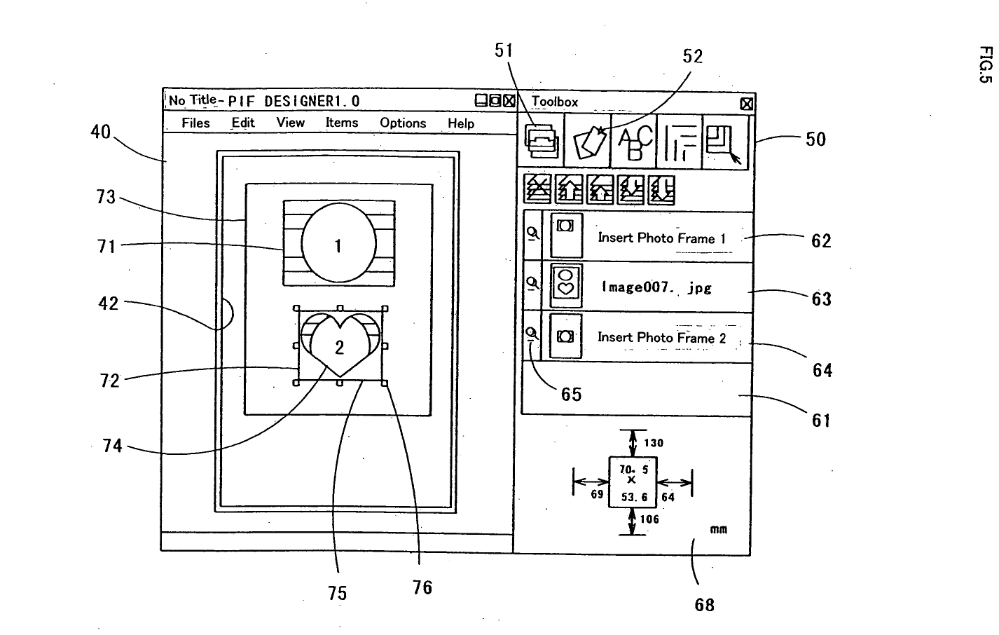

FIG. 5 shows the layout operation window 40 and the toolbox window 50, on which insert photo frames 71 and 72 are set in response to clicks of the insert photo frame button 51 and a frame image 73 is set in response to a click of the background/frame/ornamental frame button 52. As illustrated, the insert photo frame 71, the insert photo frame 72, and the frame image 73 are displayed on the layout operation window 40. The image area display operation box 61 of the toolbox window 50 includes an operation button 62 of Insert Photo Frame 1, an operation button 63 of ‘Image007.jpg’, and an operation button 64 of Insert Photo Frame 2, which are displayed sequentially from the upper layer to the lower layer and respectively correspond to the insert photo frame 71, the frame image 73, and the insert photo frame 72 as the image areas set in the printable area 42 of the layout operation window 40. The positional information display box 68 shows a relative position of a selected image area (the insert photo frame 72 in the example of FIG. 5) to the printable area 42 of the layout operation window 40. The user may locate the mouse pointer in a desired image area set in the printable area 42 of the layout operation window 40 and give a left click of the mouse to select the desired image area for various operations. For selection of a desired image area on a lower layer, the user may locate the mouse pointer on one of the operations buttons 62 to 64, which corresponds to the desired image area and is displayed in the image area display operation box 61 of the toolbox window 50, and give a left click of the mouse. In the illustrated example of FIG. 5, the user clicks the operation button 64 in the image area display operation box 61 with the mouse to select the insert photo frame 72, which is located on a lower layer below the frame image 73 in the layout operation window 40. In response to selection of an image area on the lower layer, a working frame 75 for operations appears on the location corresponding to the outer circumference of the selected image area, while the image of an image area on the upper layer is displayed. A viewing selection button 65 is provided for each of the operation buttons 62 to 64 to select either a viewing status or a non-viewing status of the image in a corresponding image area.

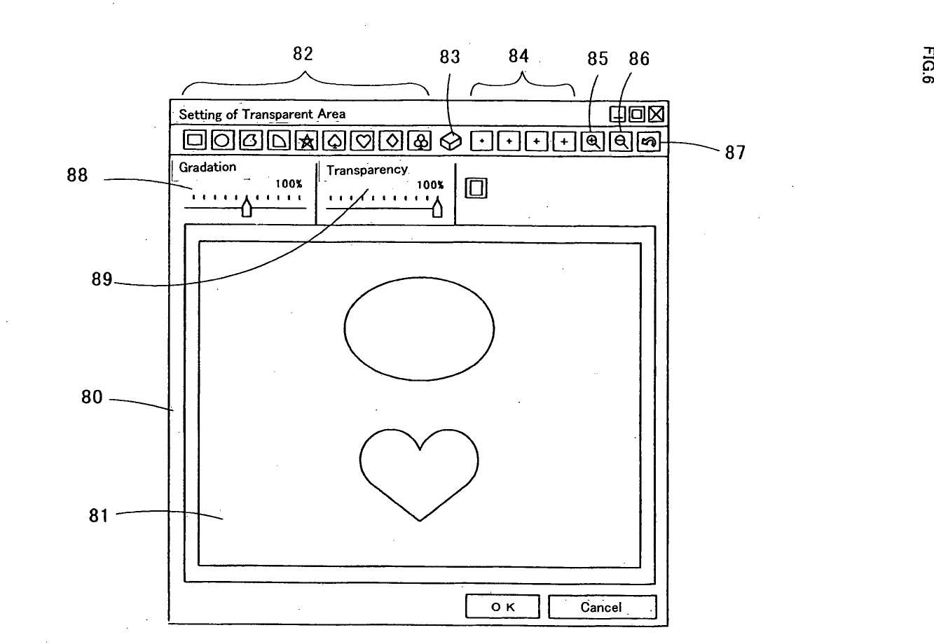

The frame image 73 set in the printable area 42 of the layout operation window 40 has a preset heart-shaped transparent area 74. A corresponding portion of the insert photo frame 72 on the lower layer is seeable through the preset transparent area 74. The transparent area 74 is set on a transparent range setting window 80 shown in FIG. 6. The transparent range setting window 80 is open in response to selective activation of an option ‘Transparent Range Setting’ in a menu (not shown) that is opened by selecting the frame image 73, locating the mouse pointer in the area of the frame image 73, and giving a right click of the mouse. The transparent range setting window 80 in the example of FIG. 6 shows an image display operation box 81 on which the frame image 73 selected in the layout operation window 40 is displayed for operations, transparent shape buttons 82 for setting rectangular, circular, heart-shaped, and other various shapes of transparent areas in the frame image 73 displayed on the image display operation box 81, an eraser button 83 for deleting each setting of the transparent area, range setting buttons 84 for setting an effective range of the mouse pointer to set or delete each transparent area, a zoom button 85 for scaling up an image, a reduction button 86 for scaling down an image, a back button 87 for bringing an executed operation back by one, a gradation scale 88 for a multi-scale setting of gradation on the border of each transparent area in a range of 0% to 100%, and a transparency scale 89 for a multi-scale setting of transparency in each transparent area in a range of 0% to 100%. Each of the gradation scale 88 and the transparency scale 89 is set by horizontally moving a corresponding scale pointer by a left click and a drag of the mouse.

The frame image 73 is defined by three channels having 8-bit tone values with regard to three primary colors, red (R), green (G), and blue (B), and a fourth channel (hereinafter referred to alpha channel) having an 8-bit tone value representing a degree of transparency. The transparent area 74 included in the frame image 73 is specified by a setting of the alpha channel. The alpha channel has an 8-bit data value (in a range of 0 to 255) with respect to each pixel. A data value ‘0’ represents a completely opaque state, a data value ‘255’ represents a completely transparent state, and intermediate data values represent various degrees of transparency. The tone values of each pixel included in an image are determined according to Equations (1) through (3) given below:
R={Rp×A+Rt×(255−A)}/255 (1)
G={Gp×A+Gt×(255−A)}/255 (2)
B={Bp×A+Bt×(255−A)}/255 (3)

In these equations, R, G, and B represent resulting tone values after composition, Rp, Gp, and Bp represent tone values of an image located on a lower layer, Rt, Gt, and Bt represent tone values of an image located on an upper layer, and A represents a data value of the alpha channel. In the absence of any image located on the lower layer, the resulting tone values R, G, and B of each pixel are determined by setting a value ‘255’ to the respective tone values Rp, Gp, and Bp.

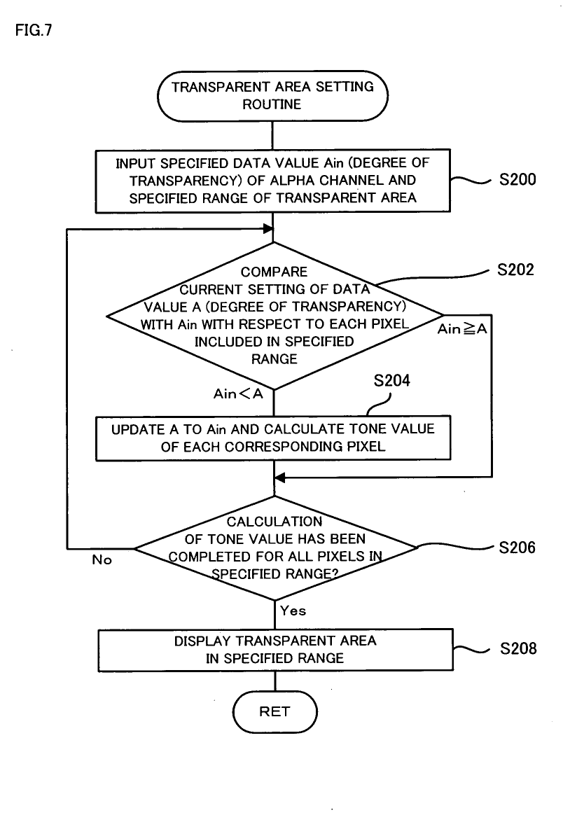

The image regulation apparatus 20 of the embodiment executes the layout edition process as discussed above. The following describes a transparent area setting process, which is characteristic of the present invention. FIG. 7 is a flowchart showing a transparent area setting routine executed by the image regulation apparatus 20 of the embodiment. This routine starts when the user specifies the range of a transparent area on the transparent range setting window 80 shown in FIG. 6 through operations of the mouse. In the illustrated example of FIG. 6, the user selects a desired shape of a transparent area, such as a rectangular shape, a circular shape, or a heart shape, by clicking one of the transparent shape buttons 82 and specifies two desired points in a frame image 73 on the transparent range setting window 80 by a left click and a drag of the mouse (where the two points represent the position of the pointer at which the left click of the mouse is effectuated and the position of the pointer at which the left click is cancelled after dragging). The range of a transparent area is thus set according to the shape of the transparent area specified by selection of one of the transparent shape buttons 82 and the distance between the two points specified by the left click and the drag of the mouse.

When the transparent area setting routine starts, the image regulation apparatus 20 of the embodiment first inputs a data value Ain of the alpha channel representing the degree of transparency specified in the range of 0% to 100% on the transparency scale 89 of FIG. 6 and the range of a transparent area specified through the mouse operations on the transparent range setting window 80 (step S200). A current setting of data value A of the alpha channel is compared with the data value Ain of the alpha channel input at step S200 for each pixel included in the input specified range (step S202). With regard to each pixel having the data value Ain of the alpha channel input at step S100 that is smaller than the current setting of data value A of the alpha channel (that is, each pixel having a lower degree of transparency) among all the pixels included in the specified range, the process updates the current setting of data value A of the alpha channel to the input data value Ain of the alpha channel and calculates the tone values of the pixel from the updated data value A according to Equations (1) through (3) given above (step S204). With regard to each pixel having the data value Ain of the alpha channel input at step S100 that is not smaller than the current setting of data value A of the alpha channel (that is, each pixel having a higher degree of transparency) among all the pixels included in the specified range, on the contrary, the process does not update the current setting of data value A of the alpha channel nor changes the tone values of the pixel. Namely the data value having the lower degree of transparency between the data value Ain representing the degree of transparency specified on the transparency scale 89 and the data value A representing the current setting of transparency is newly set to the data value A of the alpha channel.

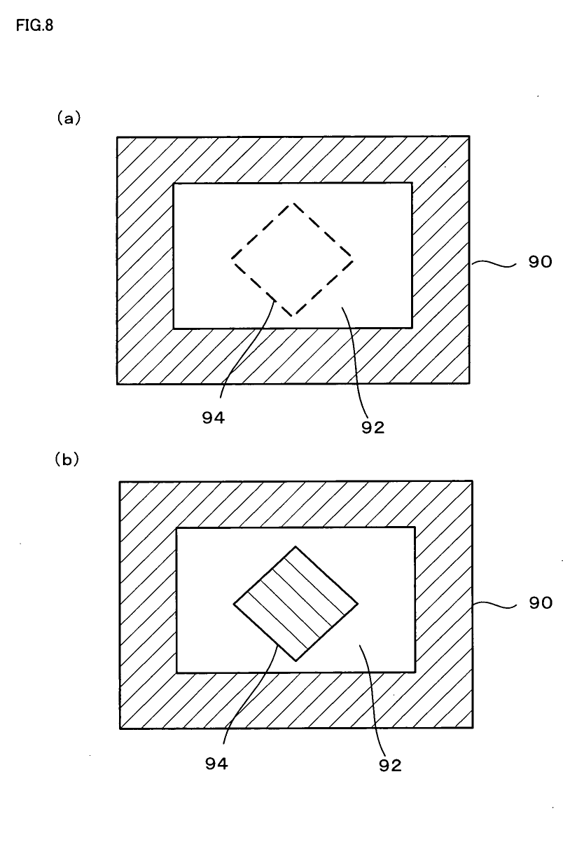

After calculation of the tone values with respect to all the pixels included in the specified range (step S206), an image of the calculated tone values is displayed as a transparent area in the specified range (step S208). The program then exits from this routine. FIG. 8 shows a process of setting a transparent area in an image. As shown in FIG. 8(a), while a rectangular transparent area 92 having a first degree of transparency has been set in advance in an image 90, the process newly specifies a second degree of transparency, which has a lower degree of transparency (greater opaqueness) than the first degree of transparency, and its range to set a rhombic transparent area 94, which is included in the rectangular transparent area 92. With regard to all the pixels included in the specified rhombic range, the data value Ain of the alpha channel representing the second degree of transparency specified as the transparency in the rhombic transparent area 94 is smaller than the current setting of data value A of the alpha channel (the first degree of transparency). The current setting of data value A of the alpha channel is accordingly updated to the data value Ain with respect to all the pixels included in the specified rhombic range. As shown in FIG. 8(b), a transparent area set on the image 90 accordingly includes the rhombic transparent area 94 having the second degree of transparency, which is laid over the rectangular transparent area 92 having the first degree of transparency. In the example of FIG. 8, the rectangular transparent area includes the whole rhombic transparent area 94. The degree of transparency is set for each pixel included in the specified range. A rhombic transparent area may thus be set in a specified range crossing over the border of the rectangular transparent area 92. In this case, the process updates the current setting of transparency to the specified degree of transparency with respect to pixels included in the rectangular transparent area 92 among all the pixels constituting the specified rhombic range, while keeping the current setting of transparency (that is, the degree of transparency representing a completely opaque state without setting of a transparent area) with respect to pixels outside the rectangular transparent area 92.

As described above, with respect to each pixel having the data value Ain of the alpha channel representing the degree of transparency specified on the transparency scale 89, which is smaller than the current setting of data value A of the alpha channel, among all the pixels included in the range of the transparent area specified by a left click and drag of the mouse, the image regulation apparatus 20 of the embodiment updates the current setting of data value A to the data value Ain and calculates the tone values of the pixel. With respect to each pixel having the data value Ain of the alpha channel representing the specified degree of transparency, which is not smaller than the current setting of data value A of the alpha channel, on the other hand, the image regulation apparatus 20 does not update the current setting of data value A nor changes the tone values of the pixel. In response to specification of a degree of transparency and its range to set a transparent area on an image, the procedure changes the current setting of transparency to the specified degree of transparency only for pixels in the specified range having the specified degree of transparency lower than the current setting of transparency. This arrangement enables multiple transparent areas having different degrees of transparency to be set in an overlapping manner and thus ensures creation of an image having diverse settings of transparent areas.

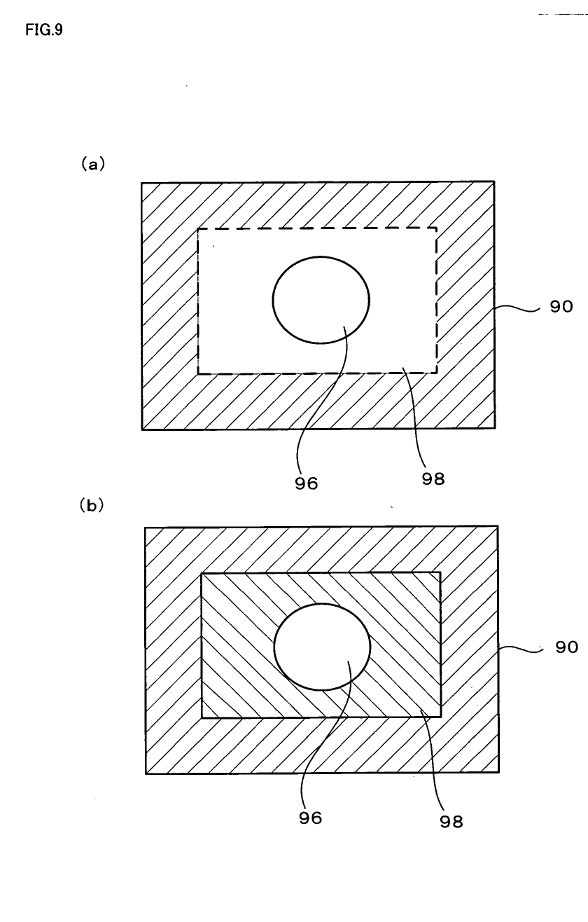

In response to specification of a degree of transparency and its range to set a transparent area on an image, with respect to each pixel having the specified data value Ain of the alpha channel that is smaller than the current setting of data value A (that is, each pixel having a lower degree of transparency) among all the pixels included in the specified range, the image regulation apparatus 20 of the embodiment updates the current setting of data value A of the alpha channel to the specified data value Ain of the alpha channel and calculates the tone value of the pixel. With respect to each pixel having the data value Ain that is not smaller than the current setting of data value A (that is, each pixel having a higher degree of transparency), on the other hand, the image regulation apparatus 20 of the embodiment does not update the current setting of data value A of the alpha channel nor changes the tone values of the pixel. One possible modification may not update the current setting of data value A of the alpha channel with respect to each pixel having the specified data value Ain of the alpha channel, which is not greater than the current setting of data value A, while updating the current setting of data value A of the alpha channel to the specified data value Ain of the alpha channel and calculating the tone values of each pixel with respect to the pixel having the specified data value Ain that is greater than the current setting of data value A. A process of setting a transparent area according to this modified procedure is shown in FIG. 9. As shown in FIG. 9(a), while a circular transparent area 96 having a first degree of transparency has been set in advance in an image 90, the process newly specifies a second degree of transparency, which has a lower degree of transparency (greater opaqueness) than the first degree of transparency, and its range to set a rectangular transparent area 98 including the circular transparent area 96. With regard to pixels belonging to the circular transparent area 96 among all the pixels included in the specified rectangular range, the data value Ain of the alpha channel representing the second degree of transparency is not greater than the current setting of data value A of the alpha channel (that is, the data value representing the first degree of transparency). The process accordingly does not update the current setting of data value A of the alpha channel and makes the circular transparent area 96 keep the first degree of transparency. With respect to pixels other than those belonging to the circular transparent area 96 among all the pixels included in the specified rectangular range, the data value Ain of the alpha channel representing the second degree of transparency is greater than the current setting of data value A of the alpha channel (that is, the degree of transparency representing a completely opaque state without setting of a transparent area). The process accordingly updates the current setting of data value A of the alpha channel to the data value Ain of the alpha channel representing the second degree of transparency. As shown in FIG. 9(b), a transparent area set on the image includes the circular transparent area 96 having the first degree of transparency, which is laid over the rectangular transparent area 98 having the second degree of transparency. Another modified arrangement enables the setting process to be selectable between the transparent area setting process executed by the image regulation apparatus 20 of the embodiment and the transparent area setting process of the modified example discussed above, for example, by selective activation of a radio button. Such modification ensures more diverse settings of transparent areas.

The above description regards the image regulation apparatus 20 that sets a transparent area having a specified degree of transparency in an image, as one embodiment of the invention. The invention may also be actualized by a corresponding image regulation method or a storage medium in which a program is stored to cause single or multiple computers to function as the image regulation apparatus 20. In the application of the storage medium, the program is installed from the storage medium into the computer and is then executed appropriately to exert the effects of the image regulation apparatus 20 of the invention.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

1. An image regulation apparatus that regulates an image, said image regulation apparatus comprising:
a transparency specification module that specifies a degree of transparency;
a transparent range specification module that specifies an arbitrary range of an image as a transparent range; and
a transparency setting module that, in response to specification of the transparent range, sets a new degree of transparency for an image in the transparent range, based on a current setting of transparency for the image in the transparent range and the degree of transparency specified by said transparency specification module.

2. An image regulation apparatus in accordance with claim 1, wherein said transparency setting module selectively sets a lower degree of transparency between the specified degree of transparency and the current setting of transparency, as the new degree of transparency for the image in the transparent range.

3. An image regulation apparatus in accordance with claim 1, wherein said transparency setting module selectively sets a higher degree of transparency between the specified degree of transparency and the current setting of transparency, as the new degree of transparency for the image in the transparent range.

4. An image regulation apparatus in accordance with claim 1, wherein said transparency setting module comprises:
a first transparency setting sub-module that selectively sets a lower degree of transparency between the specified degree of transparency and the current setting of transparency, as the new degree of transparency for the image in the transparent range; and
a second transparency setting sub-module that selectively sets a higher degree of transparency between the specified degree of transparency and the current setting of transparency, as the new degree of transparency for the image in the transparent range,
said image regulation apparatus further comprising:
a selection module that selectively activates either of said first transparency setting sub-module and said second transparency setting sub-module.

5. An image regulation apparatus in accordance with claim 1, wherein the degree of transparency is set for each pixel.

6. An image regulation apparatus in accordance with claim 1, wherein said transparency specification module is capable of specifying multiple stages of transparency in a range of 0 to 100%.

7. An image regulation apparatus in accordance with claim 1, wherein said transparent range specification module specifies two points to define the transparent range.

8. An image regulation apparatus in accordance with claim 1, said image regulation apparatus being capable of regulate a layout of image areas in which images are displayed.

9. An image regulation apparatus in accordance with claim 8, wherein one of the image areas is a frame image area, in which a frame image functioning as a frame of an arbitrary image is displayed.

10. An image regulation method that regulates an image, said image regulation method comprising the steps of:
(a) specifying a degree of transparency;
(b) specifying an arbitrary range of an image as a transparent range; and
(c) in response to specification of the transparent range, setting a new degree of transparency for an image in the transparent range, based on a current setting of transparency for the image in the transparent range and the degree of transparency specified by said step (a).

11. An image regulation method in accordance with claim 10, wherein said step(c) selectively sets a lower degree of transparency between the specified degree of transparency and the current setting of transparency, as the new degree of transparency for the image in the transparent range.

12. An image regulation method in accordance with claim 10, wherein said step(c) selectively sets a higher degree of transparency between the specified degree of transparency and the current setting of transparency, as the new degree of transparency for the image in the transparent range.

13. An image regulation method in accordance with claim 10, wherein said step(c) comprises the steps of:
(c1) selectively setting a lower degree of transparency between the specified degree of transparency and the current setting of transparency, as the new degree of transparency for the image in the transparent range; and
(c2) selectively setting a higher degree of transparency between the specified degree of transparency and the current setting of transparency, as the new degree of transparency for the image in the transparent range,
said image regulation method further comprising the step of:
(d) prior to said step(c), selectively activating either of setting by said step(c1) and setting by said step(c2).

14. An image regulation method in accordance with claim 10, wherein the degree of transparency is set for each pixel.

15. An image regulation method in accordance with claim 10, wherein said step(a) is capable of specifying multiple stages of transparency in a range of 0 to 100%.

16. An image regulation method in accordance with claim 10, wherein said step(a) specifies two points to define the transparent range.

17. A storage medium that stores therein a computer program used to regulate an image, said computer program comprising:
a module that, in response to specification of a degree of transparency and an arbitrary range of an image as a transparent range, sets a new degree of transparency for an image in the transparent range, based on a current setting of transparency for the image in the transparent range and the specified degree of transparency.
